(19) United States
(12) Patent Application Publication
(10) Pub. No.: US 2009/0061059 A1
(43) Pub. Date: Mar. 5, 2009

(54) Method for moulding a food product

(76) Inventors: Daniel Anthony Jarvis, Vlaardingen (NL); David John Judge, Sharnbrook (GB)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/918,865

(22) PCT Filed: Mar. 24, 2006
(86) PCT No.: PCT/EP2006/003028

§ 371 Date: Oct. 19, 2007

(30) Foreign Application Priority Data
Apr. 21, 2005 (EP) 05252489.9

(51) Int. Cl. A23P 1/10

(52) U.S. Cl. 426/515

(57) ABSTRACT

A method for moulding a plastic food product comprising the steps of (a) pressing a moulding surface having a temperature of from −10° C. to −5O0C. against the food product to cause at least part of the product to take up the shape of the moulding surface; and (b) removing the moulding surface from the food product characterised in that in step (a) a layer of a frozen aqueous solution is present between the food product and the moulding surface, the solution having a Tg′ below −60° C. and a solute concentration of from 0.001 to 20% by weight.

### TECHNICAL FIELD OF THE INVENTION

The present invention relates to a method for moulding food products such as ice cream by pressing a mould against the food product to cause at least part of the product to take up the shape of the mould. In particular, it relates to a method for reducing the adhesion between the food product and the moulding surface of the mould, thereby allowing easier release of the product from the mould.

### BACKGROUND

Children living in cold climates are taught from an early age that if they let their tongue touch a lamppost on a cold day, their saliva will freeze causing the tongue to adhere to the metal. This phenomenon is also manifested in the production and handling of frozen food products where adhesion to cold surfaces is a problem in many factory processes. Most foods have a high moisture content and when the water at the surface of the food product freezes, it acts as a cementing agent, producing strong adhesion to cold surfaces, such as moulds.

There is a demand for moulded frozen confectionery products with interesting and distinctive shapes, for shaped frozen meat and vegetable products, and for frozen products onto which a logo or other design is stamped. However, the ability to produce such products is hindered by the adhesion of the food to the mould, which can result in the product not being released cleanly from the mould, and hence an unsatisfactory final product shape.

One method that has been used to release frozen products is to heat the outside of the mould so that the surface of the frozen product melts, decreasing adhesion and making removal easier. However the heating step can lead to poor product surface definition, is inefficient in terms of energy usage and reduces the production rate. Therefore the elimination or reduction of the adhesion is desirable.

One approach to overcome adhesion is to coat the moulding surface with a release agent. For example U.S. Pat. No. 4,420,496 discloses the use of highly unsaturated oils as release agents. As U.S. Pat. No. 4,420,496 points out, the release agent must be capable of withstanding cold temperature without significantly congealing or hardening. U.S. Pat. No. 1,581,493 and U.S. Pat. No. 5,358,727 disclose the use of ethanol and glycerol respectively as release agents. These release agents are all non-aqueous liquids with low freezing points. Therefore instead of freezing, they form a liquid layer between the moulding surface and the product. The liquid barrier reduces the adhesion. However, release agents are used in large quantities since moulding processes are normally repeated many hundreds or thousands of times per day in a factory. Therefore this approach is expensive.

EP 0827696 discloses a method for moulding food products in which the mould temperature is kept a very low temperature, preferably below −80° C. As a result, the adhesive force between the product and the moulding surface becomes very small and good product release is achieved without the need for a release agent. However in order to reach these very low temperatures, cryogenic liquids are required. These add cost and are inconvenient to handle.

There remains therefore a need for a method of reducing the adhesion between food products and moulding surfaces thereby allowing easier release of the product from the mould, but which does not suffer from the disadvantages of previous methods.

Tests and Definitions

Unless defined otherwise, all technical and scientific terms used herein have the same meaning as commonly understood by one of ordinary skill in the art (e.g. in frozen food manufacture). Definitions and descriptions of various terms and techniques used in frozen confectionery manufacture are found in “Ice Cream”, 6^{th} Edition R. T. Marshall, H. D. Goff and R. W. Hartel, Kluwer Academic / Plenum Publishers, New York 2003.

Plastic Food Products

The term “plastic food product” as used herein includes partially frozen ice creams, water ices, vegetables, (for example spinach and cabbage), sauces (such as bechamel sauce and tomato sauce) and the like. The term plastic means that the food product should have a consistency such that it can be shaped by a mould, and retains its shape after the mould is removed.

When an aqueous solution freezes, ice is formed. As a result, the amount of unfrozen water in which the solute is dissolved decreases and the solute becomes more concentrated. This is known as freeze-concentration. If the solute does not crystallise out of solution as freezing progresses, the solution eventually becomes so concentrated that it undergoes a transition to a glassy state and does not freeze-concentrate any more. The temperature at which this occurs is the glass transition temperature of the maximally freeze-concentrated solution, known as Tg′. The frozen aqueous solution consists of a mixture of ice crystals and freeze-concentrated glassy phase. The relative amounts of ice and glass depend on the initial solute concentration, but the concentration of the glassy phase (i.e. the maximally freeze-concentrated solution) is independent of the initial solute concentration. Tg′ corresponds to the temperature at which the liquidus curve and the glass transition curve intersect on the state diagram (see, for example, C. Clarke, “The Science of Ice Cream”, 2004, Royal Society of Chemistry, Cambridge, UK, pp 28-30). Values of Tg′ are known in the literature for a wide range of food grade solutes. Tg′ is measured by the following method.

Method for Measuring Tg′

The Tg′ of aqueous solutions is measured by differential scanning calorimetry, as described in S Ablett, M J Izzard, P J Liliford, “Differential scanning calorimetric study of frozen sucrose and glycerol solutions” J. Chem. Soc. Faraday Trans., 88 (1992) p789. It should be noted that some solutes have a very low Tg′. It is sufficient for the purposes of the present invention to show by this method that Tg′ of such solutes is below −60° C., and it is not necessary to measure the actual value.

Concentration

It should be understood that references to solute concentrations mean the concentration of the solute before any ice is formed, unless stated otherwise. All concentrations are expressed as % by weight, unless stated otherwise.

Method for Measuring the Temperature of a Moulding Surface

The temperature of a moulding surface is measured with a self-adhesive patch surface temperature probe connected to a thermometer (as supplied by Comark, Stevenage, UK with code N9008).

### BRIEF DESCRIPTION OF THE INVENTION

We have developed a process that facilitates release of frozen food products from moulds. The invention requires the presence of a layer of a frozen aqueous solution (which is of a different composition to the food product) between the moulding surface and the food product. We have found, contrary to what had previously been thought, that certain frozen aqueous solutions do not cement food products to cold surfaces, but in fact reduce the adhesion between them, provided that the solute is chosen according to particular criteria. Remarkably, reduced adhesion is obtained with a low solute concentration, for example 1% by weight, or lower. We have found that this allows a food product to be removed easily from a mould without the shortcomings associated with previous methods, such as poor surface definition, or the need for large quantities of release agents or cryogenic liquids.

Accordingly, in a first aspect the present invention provides a method for moulding a plastic food product comprising the steps of
(a) pressing a moulding surface having a temperature of from −10° C. to −50° C. against the food product to cause at least part of the product to take up the shape of the moulding surface; and
(b) removing the moulding surface from the food product
   characterised in that in step (a) a layer of a frozen aqueous solution is present between the food product and the moulding surface, the solution having a Tg′ below −60° C. and a solute concentration of from 0.001 to 20% by weight.

In a preferred embodiment the moulding surface is coated with the aqueous solution before it is pressed against the food product. In an alternative embodiment the food product is coated with the aqueous solution before the moulding surface is pressed against it.

Preferably the moulding surface is not subjected to a heating step before the food product is removed from it.

Preferably the solute is food grade, for example an alcohol, a polyol or a sugar. More preferably the solute is selected from the group consisting of ethanol, glycerol, sorbitol, xylitol, propylene glycol, arabinose, ribose, xylose and mixtures thereof. Even more preferably the solute is ethanol and / or glycerol.

Preferably the solute concentration is at least 0.01%, more preferably at least 0.05% by weight. Preferably the solute concentration is at most 10%, more preferably at most 5% by weight.

In a preferred embodiment the solute is ethanol with a concentration of from 0.05 to 1% by weight.

Preferably the layer of frozen aqueous solution is at least 0.1 mm, more preferably at least 0.3 mm, most preferably at least 0.5 mm in thickness. Preferably the layer is at most 5 mm, more preferably at most 3 mm, most preferably at most 2 mm in thickness.

Preferably the temperature of the moulding surface is −15° C. or below, more preferably −25° C. or below, most preferably −30° C. or below. Preferably the temperature of the moulding surface is −45° C. or above, more preferably −40° C. or above.

Preferably the moulding surface is made of a metal, such as stainless steel or aluminium.

In a preferred embodiment the food product is a frozen aerated confection, such as ice cream. In another embodiment the food product is a vegetable product or a sauce.

In a second aspect the present invention provides the use of an aqueous solution having Tg′ below −60° C. and a solute concentration of from 0.001 to 20% by weight to reduce adhesion between a food product and a moulding surface having a temperature of from −10° C. to −50° C.

In a third aspect a product obtained by the methods of the invention is provided. Also provided is a product obtainable by the methods of the invention.

### DETAILED DESCRIPTION

It has been found that when a layer of an aqueous solution having Tg′ below −60° C. and a solute concentration of from 0.001 to 20% by weight is present between a food product and a moulding surface at a temperature from −10° C. to −50° C., the adhesion between the moulding surface and the food product is reduced. The table lists examples of solutes which (in aqueous solution) have Tg′ below −60° C.

| Class | Solute | Tg′ (° C.) | Reference |
|---|---|---|---|
| Alcohols | ethanol | −178 | C |
| | propylene glycol | −67.5 | D |
| Polyols | glycerol | −95 | B |
| | sorbitol (glucitol) | −63 | A |
| | xylitol | −72 | A |
| Sugars | arabinose | −67 | A |
| | ribose | −68 | A |
| | xylose | −65 | A |

A Y. Roos, Carbohydrate Research 238 (1993) p39
B S. Ablett et al., J. Chem. Soc. Faraday Trans. 88 (1992) p789
C M.A. Miller et al, Phys. Rev. B 57 (1998) p22
D H. Levine, L. Slade, Cryo-Letters 9 (1988) p21

The lower the value of Tg′, the lower the adhesion. Preferably Tg′ is below −70° C., more preferably below −80° C. Ethanol and glycerol have particularly low Tg′ values and are therefore particularly effective solutes. Preferably the temperature of the moulding surface at least 20° C. higher than the Tg′. Thus when a moulding surface temperature at the lower end of the range is used, the greatest reduction in adhesion is obtained by choosing a solute with a Tg′ of below −70° C.

Solutes that crystallize out of solution and form eutectic mixtures (rather than undergoing a glass transition) when freeze-concentrated, for example sodium chloride, are not suitable for the present invention. However a solute which undergoes a glass transition (e.g. a sugar) may be combined with a solute that crystallizes out of solution (e.g. a salt). A mixed solution of the solutes is suitable for the present invention provided that this mixed solution has Tg′ below −60° C.

Reduced adhesion is achieved at as long as the solute concentration is above a minimum value. An advantage of the present invention is that this minimum concentration is very low, thus the solution comprises almost entirely water. The present invention uses much less solute than previously known release agents, which typically comprise little or no water (for example 100% glycerol). A further advantage is that because the solute concentration is very low, it does not matter that some of the layer of frozen aqueous solution remains on the surface of the food product after release from the moulding surface. If the solute concentration is high, the frozen solution that remains on the surface of the food product can affect the flavour of the food product. In particular, glycerol has a very noticeable off taste which consumers do not like. Thus if the solute is glycerol, it is preferred that the solute concentration is not at the top of the concentration range.

The aqueous solution may be applied to the moulding surface or to the surface of the food product. Any suitable method may be used to apply the solution, for example by spraying, brushing, or filling a cold mould so that a solid layer forms on its inner surface and then sucking out the excess solution. Filling and sucking is especially suitable for producing relatively thick layers.

To achieve optimum adhesion reduction it is preferable to choose (within the ranges specified) a relatively thick layer when a very low solute concentration is used, and a relatively high solute concentration when a very thin layer is used.

It is important that the layer of frozen aqueous solution does not completely melt after application, for example when the food product makes contact with it. This depends on factors such as the temperature and amount of the food product, the thickness of the layer, the temperature and nature of the moulding surface and the overall heat transfer properties. A certain amount of melting can be tolerated, but the layer must not melt completely. Thick layers are less prone to melting than thin ones, but require more solution and reduce the rate of heat transfer from the product to the mould.

The reduced adhesion due to the presence of the frozen aqueous layer means that a heating step is not required between contacting the food product with the moulding surface and removing the food product from it. By a heating step is meant a step in which some of the frozen aqueous layer is melted by the application of heat to the moulding surface. The disadvantages inherent in a heating step, such as poor product surface definition, increased energy usage and reduced production rate are thereby avoided.

The present invention may be applied in any suitable moulding process. Moulds may comprise a single piece or two or more pieces which are assembled to form the mould. In many such processes, the steps are repeatedly performed in a cycle. Thus for example in a mould is filled with ice cream, which is then frozen, and the product is removed; then the next cycle begins and the mould is filled again. In such a process it is necessary that the layer of frozen aqueous solution of the invention is present in each cycle.

The food product should have a plastic consistency so that it is easily shaped by the mould, and retains its shape after the mould is removed. For example, the food product may be partially frozen ice cream. The food product should have sufficient cohesive strength that the product itself does not fail when the mould is removed. If the food product does not initially have sufficient cohesive strength, this may be achieved by keeping the food product in the cold mould so that more ice is formed, before removing the mould.

The present invention will now be further described with reference to the following example, which is illustrative only and non-limiting.

### EXAMPLE

A standard ice cream mix was prepared by conventional techniques. It was frozen and aerated (to 60% overrun) in a conventional ice cream freezer and extruded from a low temperature extruder at approximately −10° C. through an oval shaped nozzle. The ice cream was cut into 25 mm thick pieces with a cutting wire as it was extruded, and sticks were inserted. The resulting pieces had an oval cross-section (from the nozzle) and flat upper and lower surfaces (from the cutting wire). Stainless steel moulds having a indentation with an oval cross-section of approximately the same size and shape as the ice cream piece and a rounded bottom with a maximum depth of 7 mm were cooled to −30° C. A layer of 0.1% w/w ethanol solution was sprayed onto the moulding surface using an artists' air brush. A small amount of red food colouring had been added to the solution so that the coating layer could be clearly seen. The solution was left to solidify for 5 minutes. The ice cream was then placed onto the indentation and stamped into the mould by bringing an aluminium cold plate down onto it from above. This resulted in the bottom side of the ice cream piece taking up the shape of the mould. After each ice cream sample had been stamped, the mould containing the stamped ice cream was returned to the blast freezer at −35° C. for hardening. This step is included because the ice cream was still relatively soft and would undergo cohesive failure if it were attempted to remove it from the mould without hardening. The example was repeated without using the ethanol solution.

After 40 minutes, moulds were removed from the blast freezer and the ice creams were held by the stick and lifted from the moulds. The ice cream stuck very firmly to the uncoated moulds. In some cases the sticks in the uncoated samples snapped since the adhesion was so strong. The ice cream could only be lifted after banging the mould hard onto a table. In contrast, the ice creams were released from the coated moulds when lifted by the stick. Coated moulds had greatly reduced adhesion compared to the uncoated ones.

The various features of the embodiments of the present invention referred to in individual sections above apply, as appropriate, to other sections mutatis mutandis. Consequently features specified in one section may be combined with features specified in other sections as appropriate.

All publications mentioned in the above specification are herein incorporated by reference. Various modifications and variations of the described methods and products of the invention will be apparent to those skilled in the art without departing from the scope of the invention. Although the invention has been described in connection with specific preferred embodiments, it should be understood that the invention as claimed should not be unduly limited to such specific embodiments. Indeed, various modifications of the described modes for carrying out the invention which are apparent to those skilled in the relevant fields are intended to be within the scope of the following claims.

1. A method for moulding a plastic food product comprising the steps of
(a) pressing a moulding surface having a temperature of from −10° C. to −50° C. against the food product to cause at least part of the product to take up the shape of the moulding surface; and
(b) removing the moulding surface from the food product characterised in that in step (a) a layer of a frozen aqueous solution is present between the food product and the moulding surface, the solution having a Tg′ below −60° C. and a solute concentration of from 0.001 to 20% by weight.

2. A method according to claim 1 wherein the moulding surface is coated with the aqueous solution before it is pressed against the food product.

3. A method according to claim 1 wherein the food product is coated with the aqueous solution before the moulding surface is pressed against it.

4. A method according to claim 1 wherein the moulding surface is not subjected-to a heating step between step (a) and step (b).

5. A method according to claim 1 wherein the solute is selected from the group consisting of ethanol, glycerol, propylene glycol and mixtures thereof.

6. A method according to claim 5 wherein the solute is ethanol and/or glycerol.

7. A method according to claim 1 wherein the solute concentration is from 0.01% to 10% by weight.

8. A method according to claim 1 wherein the layer of frozen aqueous solution is from 0.1 mm to 5 mm in thickness.

9. A method according to claim 8 wherein the layer of frozen aqueous solution is from 0.5 mm to 2 mm in thickness.

10. A method according to claim 1 wherein the temperature of the moulding surface is from −15° C. to 45° C.

11. A method according to claim 1 wherein the food product is a frozen aerated confection.

12. Use of an aqueous solution having Tg′ below −60° C. and a solute concentration of from 0.001 to 20% by weight to reduce adhesion between a food product and a moulding surface having a temperature of from −10° C. to −50° C.

13. A product obtainable by the method of claim 1.
